(19) United States
(12) Patent Application Publication
(10) Pub. No.: US 2003/0080968 A1
(43) Pub. Date: May 1, 2003

(54) Image display system and recording medium

(76) Inventors: Masahito Niikawa, Sakai-Shi (JP); Jun Minakuti, Sakai-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/273,239

(22) Filed: Oct. 17, 2002

(30) Foreign Application Priority Data
Oct. 19, 2001 (JP) 2001-321794

(51) Int. Cl. G09G 5/00; G09G 5/02

(52) U.S. Cl. 345/589; 345/204

(57) ABSTRACT

A profile conversion 40 is performed by a CPU 15 of a computer. In the profile conversion 40, an ICC profile PFb of a projector 20 is profile-converted based on an ICC profile PFc of a screen 30, angle information DA and ambient light information DB. Consequently, color correction information obtained by the profile conversion is information reflecting the color reproduction characteristic of the screen 30, the angle at which the screen 30 is viewed and the effect of the ambient light, and by performing color correction based on the color correction information in a gamut adjustment 42, an image with high color reproducibility can be projected onto the screen 30.

This application is based on application No. 2001-321794 filed in Japan, the content of which is hereby incorporated by reference.

### BACKGROUND OF THE INVENTION

1. Field of the Invention

The present invention relates to an image display system for displaying images, and more particularly, to a technique of correcting image data when images are displayed.

2. Description of the Related Art

It has been frequently performed to project images onto a display such as a large screen by using a projector, for example, when a business presentation is made. Moreover, there are cases where a meeting is performed in a comparatively small meeting room or the like while images are displayed on a display such as a liquid crystal display or a CRT display.

However, when an original image is displayed on a screen by using a projector, in some conditions of the display system, the displayed image appears to the viewers to be different in color from the original images.

For example, when a drawing or a graph using a multiplicity of colors is generated by a computer and displayed on a large screen, there are cases where the displayed image appears to the viewers to be different in color tone from the original image viewed on the computer screen and the colors used for the drawing or the graph cannot be distinguished visually.

Moreover, when an image is projected onto a screen and when an image is displayed on a liquid crystal display, since the image appears differently when viewed from different directions, there are cases where the colors used for the drawing or the graph cannot be distinguished visually.

Further, the effect of ambient light such as room lighting and light incident through a window makes the image displayed on the display different in impression from the original image.

### SUMMARY OF THE INVENTION

The present invention is made in view of the above-mentioned problem, and an object thereof is to obtain an image display system that enables appropriate image display on a display such as a screen and a liquid crystal display.

To attain the above-mentioned object, one aspect of the present invention is an image display system displaying an image on a display having a substantially flat surface. The image display system is provided with: an input part accepting input of angle information on an angle between a line of sight when an image displayed on the display is viewed, and the screen; a corrector correcting image data to be displayed on the display, according to the angle information; and a display controller performing image display on the display based on the image data corrected by the corrector.

Another aspect of the present invention is an image display system displaying an image by projecting the image onto a screen. The image display system is provided with: an input part accepting input of ambient light information on ambient light with which the screen is irradiated; and a corrector correcting image data to be projected onto the screen, according to the ambient light information.

Yet another aspect of the present invention is an image display system displaying an image by projecting the image onto a screen. The image display system is provided with: a memory storing color correction information based on a characteristic of the screen; and a corrector color-correcting image data to be projected onto the screen, based on the color correction information.

Still another aspect of the present invention is a computer-readable recording medium in which color correction information is stored. The color correction information is used when an image is projected from a projector onto a screen, and the color correction information is based on a characteristic of the screen.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 showing an embodiment of the present invention is a conceptual illustration showing a condition of use of an image display system;

FIG. 2 is a view showing the hardware structure of the image display system;

FIG. 3 is a view showing the concept of image correction in the image display system;

FIG. 4 is a view showing a screen displayed on the display;

FIG. 5 is a view showing a screen displayed on the display;

FIG. 6 is a view showing a tone reproduction curve of a screen;

FIG. 7 is a view showing a conversion characteristic based on angle information;

FIG. 8 is a view showing a conversion characteristic based on the brightness of the ambient light;

FIG. 9 is a view showing a conversion characteristic in fluorescent light; and

FIG. 10 is a view showing a conversion characteristic in incandescent light.

### DETAILED DESCRIPTION OF THE PREFERRED EMBODIMENTS

An embodiment of the present invention will be described in detail with reference to the drawings.

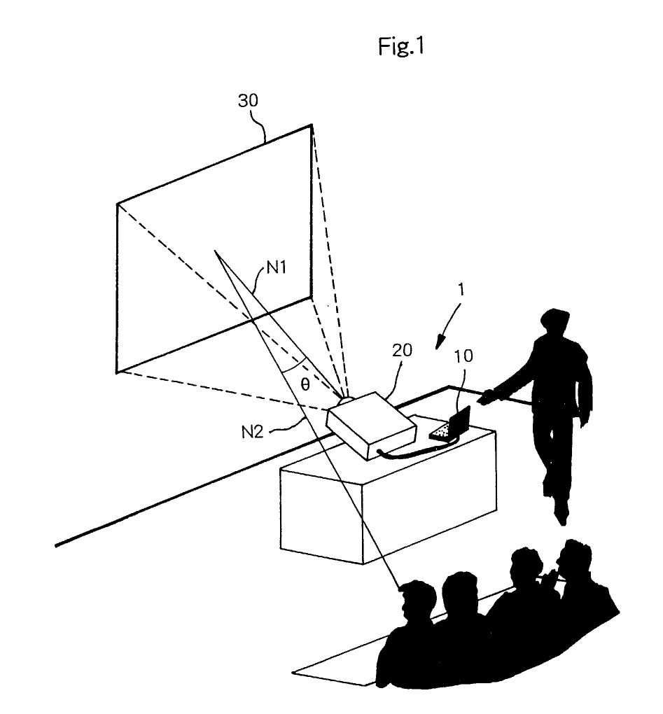

As shown in FIG. 1, an image display system 1 has a computer 10 and a projector 20, and performs image display by projecting images onto a screen 30 placed so as to face the projector 20. The computer 10 is an apparatus for outputting to the projector 20 the image data of the image to be projected. The projector 20 generates an image for projection based on the image data input from the computer 10, and projects the generated image onto the screen 30.

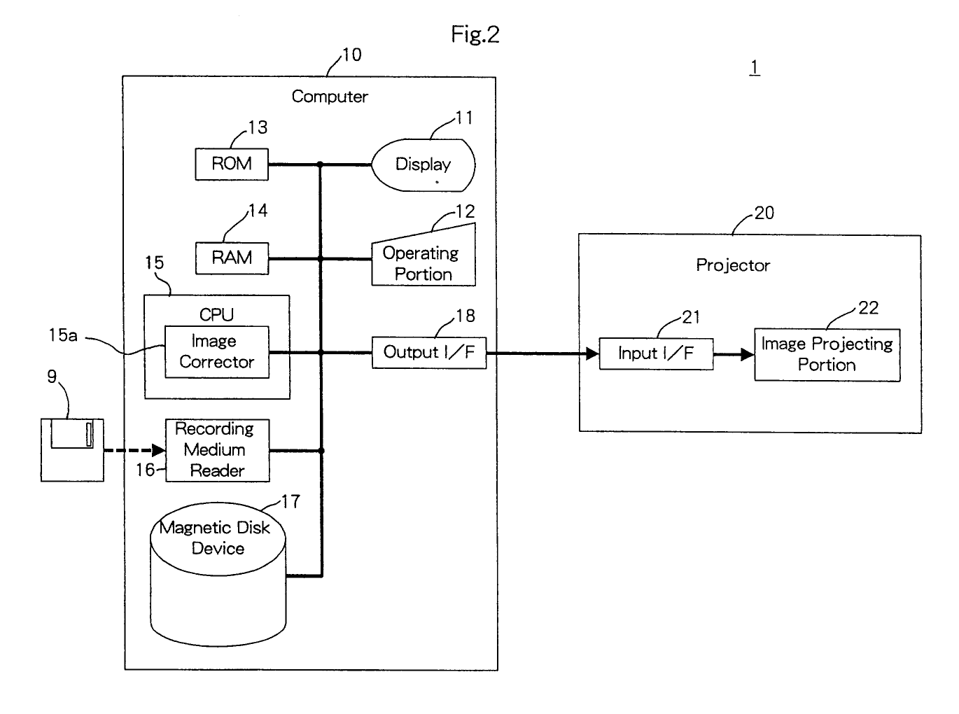

As shown in FIG. 2, the computer 10 has: a display 11 comprising a liquid crystal display or a CRT display; an operation portion 12 such as a keyboard and a mouse; a ROM 13 storing data and programs; a RAM 14 storing temporary data and the like when a CPU 15 performs a computation such as image correction; the CPU 15 functioning as an image corrector 15a correcting image data when the image data is output to the projector 20; a recording medium reader 16 reading data stored on a portable recording medium 9 such as a CD-ROM; a magnetic disk unit 17 storing image data, color correction information and the like; and an output interface 18 for outputting image data to the projector 20. The magnetic disk unit 17 may be replaced with a different storage device capable of a large amount of data.

The projector 20 has an input interface 21 and an image projection portion 22. When image data is input from the computer 10, the image projector 22 generates an image for projection based on the image data, and projects the image for projection onto the screen 30.

In the image display system 1 structured as described above, image data is previously generated or input, and stored in the magnetic disk unit 17. At this time, an ICC (International Color Consortium) profile for color management used for optimally reproducing the colors of the image is associated with the image data. The ICC profile is data (color correction information) for performing color correction. Color reproducibility can be improved by color-correcting image data based on the ICC profile.

In generating an image for projection by the projector 20, the color reproducibility varies according to the characteristic of the projector 20. For example, when the color of the light source for projecting the image is different, the image reproducibility is different. For this reason, to generate image data with high reproducibility in generating an image for projection by the projector, it is desired that the image data be color-corrected according to the characteristic of the projector 20.

Therefore, for example, when the projector 20 is sold, a recording medium such as a CD-ROM storing an ICC profile for performing color correction according to the characteristic of the projector 20 is packaged with the projector 20, and the computer 10 reads the ICC profile particular to the projector 20 from the recording medium and stores it on the magnetic disk unit 17 or the like. When image data is output to the projector 20, the computer 10 corrects the image data based on the ICC profile particular to the projector 20. This improves the color reproducibility of the image generated by the projector 20. When the projector 20 and the computer 10 are capable of two-way data communication with each other, the ICC profile may be transmitted from the projector 20 to the computer 10 not through a recording medium but by direct data communication.

The screen 30 has a substantially flat display surface, and reflects the image projected by the projector 20. The reason why the viewer can view the displayed image on the screen 30 is that the image projected onto the screen 30 is reflected at the display screen and the reflected image is captured by the viewer's sense of sight. The reflectance of each color component at the screen 30 is a characteristic value particular to the screen 30. When the reflectance is different, the viewer views an image different in color tone. That is, when the characteristic of the screen 30 is different, even if the same image is projected from the projector 20, image display is performed under a condition where the color reproducibility is different. To suppress this phenomenon to display an image with high reproducibility on the screen 30, it is desired that the image data be color-corrected according to the characteristic of the screen 30.

Therefore, for example, when the screen 30 is sold, a recording medium such as a CD-ROM storing an ICC profile for color-correcting the image data according to the characteristic of the screen 30 is packaged with the screen 30, and the computer 10 reads the ICC profile particular to the screen 30 from the recording medium and stores it on the magnetic disk unit 17 or the like. When image data is output to the projector 20, the computer 10 color-corrects the image data not only based on the ICC profile particular to the projector 20 but also based on the ICC profile particular to the screen 30. Consequently, when projected onto the screen 30, the image generated by the projector 20 is an image where the color tone of the original image is reproduced as precisely as possible.

In the image display system 1, as shown in FIG. 1, the image data is corrected according to the angle θ between an axis of projection N1 from the projector 20 and a line of sight N2 of the viewer viewing the screen 30 and according to the condition of the ambient light such as room lighting.

As described above, when the computer 10 outputs image data stored on the magnetic disk unit 17 to the projector 20, the CPU 15 reads and executes a predetermined program stored in the ROM 13 or the magnetic disk unit 17 to thereby realize a function as the image corrector 15a, and when the image is projected onto the screen 30, correction to improve the reproducibility of the image is performed.

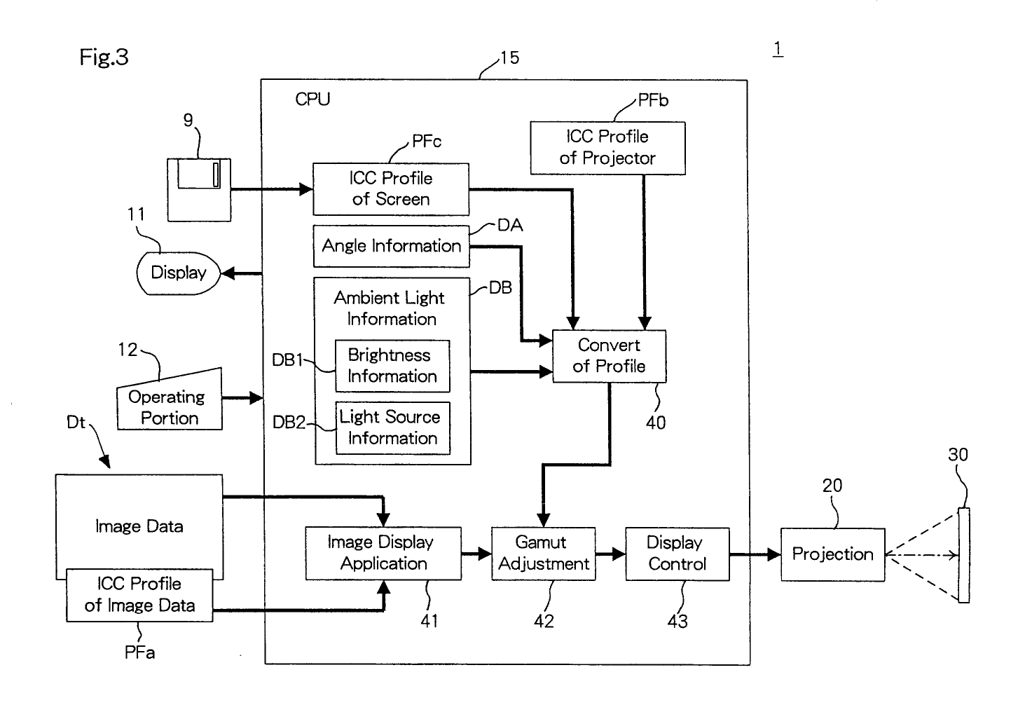

As shown in FIG. 3, the CPU 15 reads image data Dt stored on the magnetic disk unit 17 and an ICC profile PFa of the image data. Then, an image display application 41 launched by the CPU 15 performs on the image data Dt a color correction reflecting the color correction information of the ICC profile PFa.

At this time, when the principle of a general color management system is applied, and if the input image data Dt is, for example, image data expressed by an RGB color notation system, the image data Dt is converted into image data expressed by a color notation system of a profile connection space (PCS) independent of the characteristic of the apparatus such as the display 11. In the present embodiment, the image data Dt expressed by the RGB color notation system is converted into image data expressed by an XYZ color notation system.

While a color correction based on an ICC profile PFb particular to the projector 20 is also performed by the CPU 15, when the user provides an instruction to also perform a color correction based on an ICC profile PFc particular to the screen 3, the ICC profile PFb of the projector 20 is converted in a profile conversion 40 by using the ICC profile PFc of the screen 30. Then, applying the converted ICC profile, color correction is performed in a gamut adjustment 42.

Moreover, to the CPU 15, angle information when the viewer views the screen 30, that is, information DA on the angle θ between the axis of projection N1 and the line of sight N2, and ambient light information DB on room lighting and the like are input from the operation portion 12, and in the profile conversion 40, a profile conversion reflecting the angle information DA and the ambient light information DB is performed. The ambient light information DB includes brightness information DB1 on the brightness of the ambient light and light source information DB2 for identifying the kind of the light source.

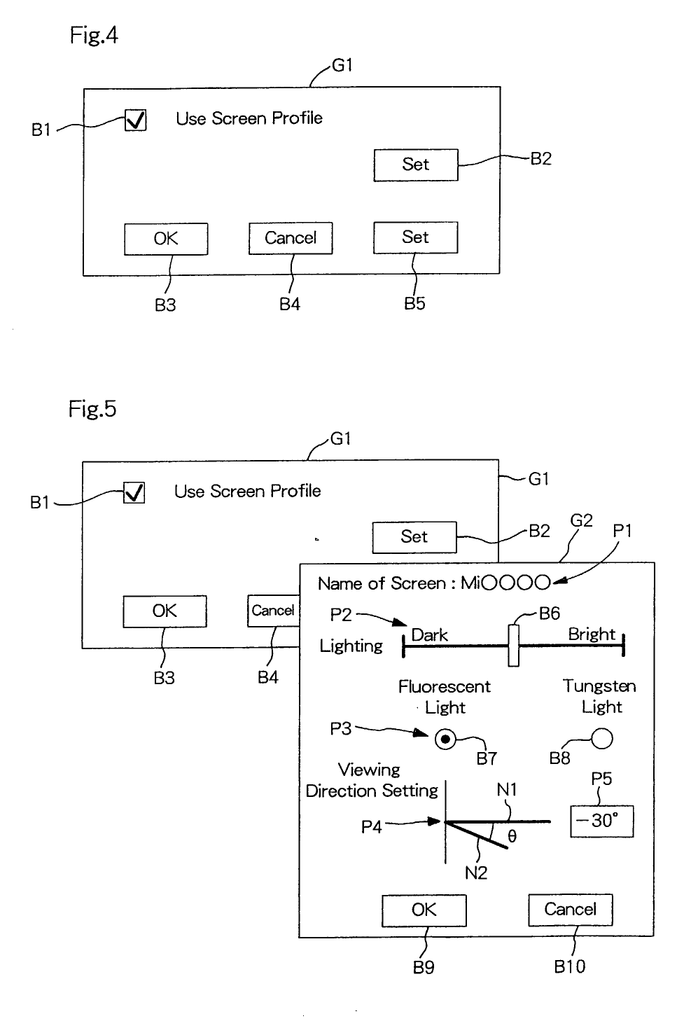

FIGS. 4 and 5 show screens displayed on the display 11 when the angle information DA and the ambient light information BD are input. When the CPU 15 functions as the image corrector 15a, first, an indication G1 in FIG. 4 is shown on the display 11. On the indication G1, the user operates the operation portion 12 to check a check box B1 for designating whether to perform the image correction using the ICC profile of the screen 30 or not.

Then, by clicking an OK button B3 or an apply button (set button) B5, the setting for performing the image correction using the ICC profile of the screen 30 is reflected in the system. When a cancel button B4 is clicked, the display of the screen GI is finished without the setting for performing the image correction using the ICC profile of the screen 30 being reflected in the system.

When a set button B2 is clicked, the display condition of the display 11 is changed as shown in FIG. 5. That is, another indication G2 is displayed so as to be superimposed on the indication G1. On the indication G2, the user inputs the angle information DA and the ambient light information DB.

In an upper part of the indication G2, a name display P1 of the screen 30 is provided, and below it, a display for setting the condition of the room lighting is provided. The display for setting the condition of the room lighting includes a track bar display P2 for setting the brightness of the room lighting and a choice button display P3 for choosing in an alternative way the kind of the light source from between fluorescent light and incandescent light, that is, tungsten light. The user can input the brightness information DB1 of the ambient light information DB by moving a slider B6 rightward or leftward according to the brightness of the room lighting. Moreover, the user can input the light source information DB2 of the ambient light information DB by choosing one of the radio buttons B7 and B8 provided so as to correspond to fluorescent light and tungsten light in the choice button display P3, respectively.

Moreover, on the screen G2, guidance displays P4 and P5 for setting the angle of line of sight of the viewer viewing the screen 30 are provided below the choice button display P3. The guidance display P4 is for the user to set the angle θ between the axis of projection N1 from the projector 20 and the line of sight N2 by inputting the angle θ by moving the line display of the line of sight N2. The guidance display PS is for the user to directly numerically input the angle θ between the axis of projection N1 from the projector 20 and the line of sight N2.

In order that the ambient light information DB and the angle information DA being input are reflected in the system, the user clicks the OK button B9, and in order that they are not reflected, the user clicks a cancel button B10. Then, the display condition returns to the display of the screen G1 of FIG. 4.

Returning to FIG. 3, the angle information DA and the ambient light information DB input as described above are supplied to the profile conversion 40, and profile conversion is performed.

Generally, the ICC profile PFb of the projector 20 includes conversion information for performing the conversion from the color notation system (RGB color notation system) based on the characteristic of the projector 20 to the color notation system (XYZ color notation system) independent of the projector 20. Then, a gamut adjustment appropriate for the projector 20 is performed in the gamut adjustment 42, and based on the conversion information, the image data expressed by the color notation system (XYZ color notation system) of the PCS independent of the projector 20 is converted into image data of the color notation system (RGB color notation system) reflecting the characteristic of the projector 20.

However, in general computers, although it is possible to perform, in the gamut adjustment 42, a color correction reflecting the ICC profile of the output apparatus (in the present embodiment, the projector 20) outputting images, it is sometimes difficult to perform a color correction reflecting the ICC profile of the medium (in the present embodiment, the screen 30 ) to which the output apparatus outputs the images.

Therefore, in the present embodiment, after the ICC profile PFb of the projector 20 is profile-converted based on the ICC profile PFc of the screen 30, the angle information DA and the ambient light information DB in the profile conversion 40, the gamut adjustment and the color notation system conversion are performed in the gamut adjustment 42 by using the profile of the projector 20 converted in the profile conversion 40. This structure enables the color correction reflecting the ICC profile of the screen 30 to be performed, for example, even when the gamut adjustment 42 does not support the color correction based on the angle information DA and the ambient light information DB.

Now, an example of the profile conversion will be described. When the values of the color components R (red), G (green) and B (blue) of the image reproduced by the projector 20 are Dr, Dg and Db, respectively, the conversion expression, based on the ICC profile PFb of the projector 20, for converting Dr, Dg and Db into those of the XYZ color notation system is generally expressed as follows:

$$[ \begin{matrix}X \\ Y \\ Z\end{matrix} ] = C [ \begin{matrix}p\_TRCr [ Dr ] \\ p\_TRCg [ Dg ] \\ p\_TRCb [ Db ]\end{matrix} ] \qquad ( 1 )$$

In the expression (1), C is a 3 by 3 matrix, and is a parameter for calculating a part where the color components R, G and B affect one another when the conversion from the RGB color notation system to the XYZ color notation system is performed. Moreover, p_TRCr, p_TRCg and p_TRCb are tone reproduction curves for the color components R, G and B, and are parameters for correcting the non-linear characteristics of the color components particular to the projector 20 into values of the color components R, G and B reflecting the characteristic of the projector 20. Thus, values of the color components R, G and B reflecting the characteristic of the projector 20 are obtained by performing a conversion based on the tone reproduction curves p_TRCr, p_TRCg and p_TRCb by using as inputs the values Dr, Dg and Db of the color components reproduced by the projector 20.

In the profile conversion in the present embodiment, the tone reproduction curves p_TRCr, p_TRCg and p_TRCb of the projector 20 are corrected based on the ICC profile PFc of the screen 30, the angle information DA and the ambient light information DB.

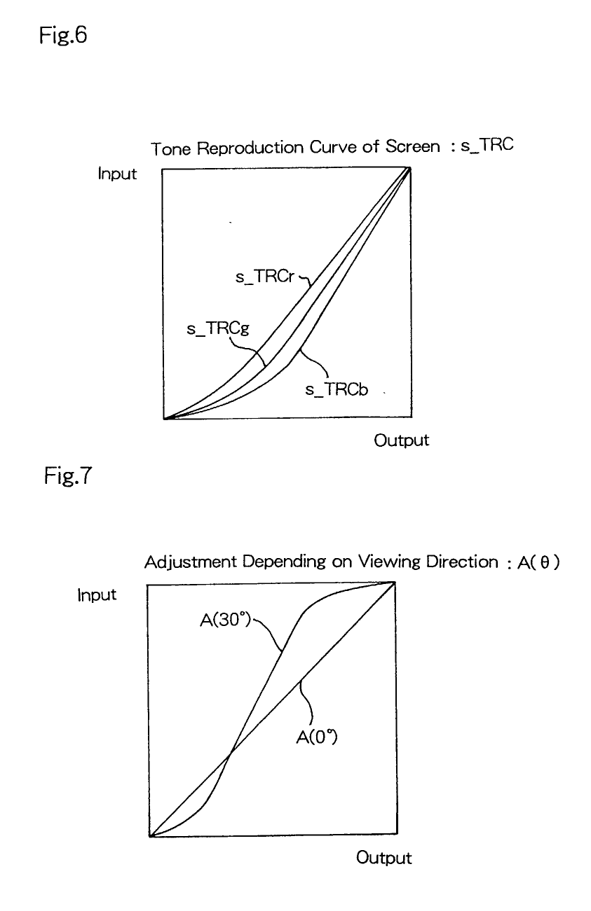

FIG. 6 is a view showing a tone reproduction curve s_TRC of the screen 30. The ICC profile PFc of the screen 30 includes tone reproduction curves as shown in FIG. 6. That is, input signals of the color components R, G and B undergo conversions based on tone reproduction curves s_TRCr, s_TRCg and s_TRCb to be converted into output signals. By this conversion, the values of the color components R, G and B reproduced on the screen 30 can be converted into values of the color components R, G and B reflecting the characteristic of the screen 30.

Thus, values of the color components R, G and B reflecting the characteristic of the projector 20 and the characteristic of the screen 30 are obtained by performing image conversion based on the tone reproduction curve p_TRC of the projector 20 and the tone reproduction curve s_TRC of the screen 30.

FIG. 7 is a view showing a conversion characteristic A(θ) based on the angle information DA. The conversion characteristic A(θ) varies according to the angle θ between the axis of projection N1 and the line of sight N2. For example, as shown in FIG. 7, when the angle θ is 0°, the conversion characteristic is A(0°) where the input value is equal to the output value, whereas when the angle θ is 30°, the conversion characteristic is A(30°). When the angle θ is 0°<θ<30°, the conversion characteristic takes an intermediate value between the conversion characteristics A(0°) and A(30°) according to the angle θ. That is, a plurality of conversion characteristics A(θ) to be applied according to the angle θ is pre-registered in the computer 10, and a conversion characteristic A(θ) corresponding to the angle information DA is selected. The conversion characteristic A(θ) based on the angle information shown in FIG. 7 is the same for the color components.

Then, by performing image conversion based on the tone reproduction curve p_TRC of the projector 20 and the conversion characteristic A(θ) based on the angle information DA, values of the color components R, G and B are obtained that reflect the angle θ of the line of sight of the viewer viewing the screen 30. Consequently, the viewer viewing the screen 30 from the angle θ can view an image substantially in agreement with the original image.

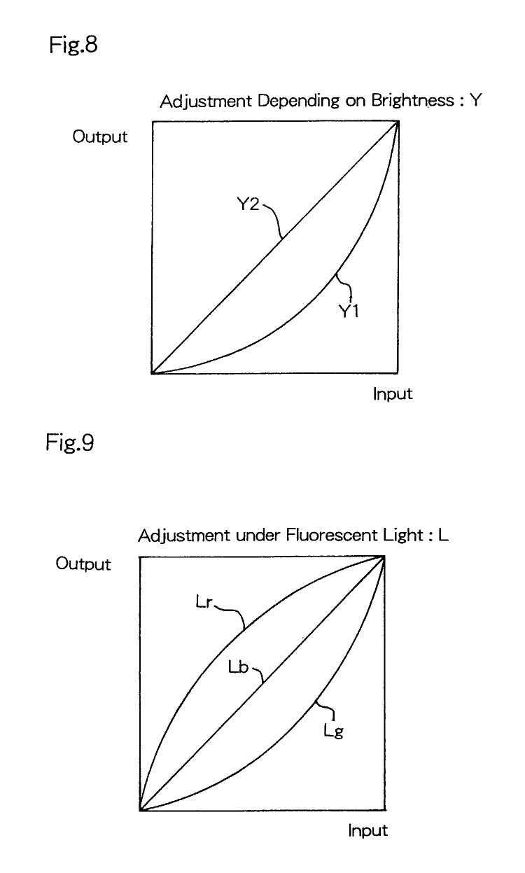

FIG. 8 is a view showing a conversion characteristic Y based on the brightness of the ambient light, that is, the brightness information DB1. When the ambient light is bright, the brightness information DB1 is high, and the conversion characteristic Y1 shown in FIG. 8 is selected. When the ambient light is dark, the brightness information DB1 is low, and the conversion characteristic Y2 shown in FIG. 8 is selected. When the brightness of the ambient light takes an intermediate value, the conversion characteristic Y also takes an intermediate value between the conversion characteristics Yl and Y2. That is, a plurality of conversion characteristics Y to be applied according to the brightness information DB1 is pre-registered in the computer 10, and a conversion characteristic Y corresponding to the brightness information DB1 is selected. The conversion characteristic Y based on the brightness information DB1 shown in FIG. 8 is the same for the color components.

Then, by performing image conversion based on the tone reproduction curve p_TRC of the projector 20 and the conversion characteristic Y based on the brightness information DB1, values of the color components R, G and B are obtained that reflect the brightness of the room lighting or the like in which image display is provided. Consequently, the viewer viewing the image displayed on the screen 30 can view an image as faithful to the original image as possible.

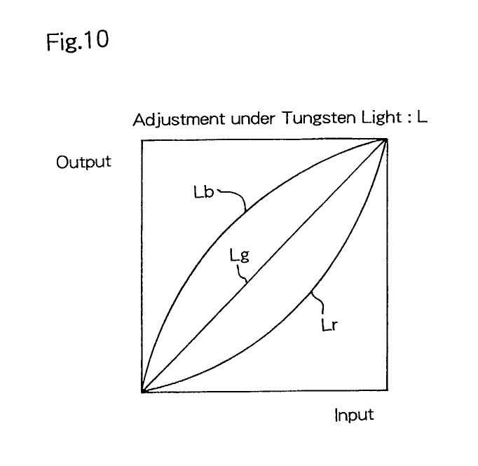

FIGS. 9 and 10 are views showing conversion characteristics L in fluorescent light and in incandescent light, that is, tungsten light. When the user's selection of the light source (that is, the light source information DB2) is fluorescent light, the conversion characteristics Lr, Lb and Lg shown in FIG. 9 are applied. When the user's selection of the light source is tungsten light, the conversion characteristics Lb, Lg and Lr shown in FIG. 10 are applied. The conversion characteristics Lr, Lb and Lg are for the R, B and G components, respectively. By such conversion characteristics Lr, Lb and Lg, the problem can be solved that the color tone of the image projected onto the screen 30 changes according to the kind of the light source.

Then, by performing image conversion based on the tone reproduction curve p_TRC of the projector 20 and the conversion characteristics Lr, Lb and Lg based on the light source information DB2, values of the color components R, G and B are obtained that take into consideration the light source color of the room environment or the like in which image display is performed. Consequently, the viewer viewing the image displayed on the screen 30 can view an image as faithful to the original image as possible.

It is to be noted that the above-mentioned conversion characteristics including the tone reproduction curve are merely an example and different conversion characteristics may be adopted.

As described above, in the profile conversion 40 of the present embodiment, the tone reproduction curve p_TRC in the ICC profile PFb of the projector 20 is converted based on the ICC profile PFc of the screen 30, the angle information DA and the ambient light information DB.

That is, for the R component, the tone reproduction curve p_TRCr, for the R component, of the projector 20 is converted by the following conversion expression (2):

Hr=p_{—}TRCr×s_{—}TRCr×A(θ)×Y×Lr (2)

In the expression (2), Hr is the converted tone reproduction curve for the R component, s_TRCr is the tone reproduction curve of the screen 30, A(θ) is the conversion characteristic based on the angle information DA, Y is the conversion characteristic based on the brightness information DB1, and Lr is the conversion characteristic based on the light source information DB2.

For the G component, the tone reproduction curve p_TRCg, for the G component, of the projector 20 is converted by the following conversion expression (3):

Hg=p_{—}TRCg×s_{—}TRCg×A(θ)×Y×Lg (3)

For the B component, the tone reproduction curve p_TRCb, for the B component, of the projector 20 is converted by the following conversion expression (4):

Hb=p_{—}TRCb×s_{—}TRCb×A(θ)×Y×Lb (4)

In the expressions (3) and (4), Hg and Hb are the converted tone reproduction curves for the R and the B components, s_TRCg and s_TRCb are the tone reproduction curves, for the G and the B components, of the screen 30, A(θ) is the conversion characteristic based on the angle information DA, Y is the conversion characteristic based on the brightness information DB1, and Lg and Lb are the conversion characteristics of the G and the B components based on the light source information DB2.

Consequently, from the expressions (1) to (4), by applying a computation shown by the following expression (5), the image projected onto the screen 30 can be converted into image data of the XYZ color notation system independent of the apparatus and the medium:

$$[ \begin{matrix}X \\ Y \\ Z\end{matrix} ] = C [ \begin{matrix}Hr [ Dr ] \\ Hg [ Dg ] \\ Hb [ Db ]\end{matrix} ] \qquad ( 5 )$$

This means that the expression of inverse conversion of the expression (5) is an arithmetic expression for converting the image data expressed by the XYZ color notation system into image data expressed by the values Dr, Dg and Db of the R, G and B components of the image reproduced by the projector 20.

In the gamut adjustment 42, the image data Dt expressed by the XYZ color notation system is converted based on the arithmetic expression of inverse conversion of the expression (5) to generate image data expressed by the RGB color notation system. At this time, in the gamut adjustment 42, gamut adjustment appropriate for the projector 20 and the screen 30 is performed at the same time.

Consequently, the image data generated in the gamut adjustment 42 is image data on which an appropriate image correction has been performed so that the image projected onto the screen 30 based on the image data agrees with the original image when viewed by the viewer. That is, in the gamut adjustment 42, image processing reflecting the ICC profile PFc of the screen 30, the angle information DA and the ambient light information DB is performed, so that a projected image having appropriate color reproducibility is displayed on the screen 30.

Then, in a display control 43, the image data on which the image correction has been performed is supplied to the projector 20. Then, when an image for projection is generated by the projector 20, an image for projection taking into consideration all of the image reproduction characteristic of the projector 20, the image reproduction characteristic of the screen 30, the image reproduction characteristic based on the angle between the viewer's line of sight and the screen 30 and the image reproduction characteristic based on the effect of the ambient light can be generated and projected onto the screen 30. Consequently, when the viewer views the displayed image projected onto the screen 30, an image reproduced in a condition similar to the original image can be viewed, so that even in the case of an image such as a graph produced by using a multiplicity of colors, the viewer can distinguish all the colors similarly to the original image.

As described above, in the profile conversion 40, the ICC profile PFb of the projector 20 is profile-converted based on the ICC profile PFc of the screen 30, the angle information DA and the ambient light information DB. Consequently, the color correction information obtained by the profile conversion is information reflecting the color reproduction characteristic of the screen 30, the angle at which the screen 30 is viewed and the effect of the ambient light, and by performing color correction based on the color correction information in the gamut adjustment 42, an image with high color reproducibility can be projected onto the screen 30.

As described above, in the present embodiment, since the ICC profile PFc which is color correction information when an image is projected from the projector 20 onto the screen 30, and is based on the characteristic of the screen 30 is recorded on the recording medium 9 which is readable by the computer, image correction based on the characteristic of the screen 30, particularly, color correction based on the ICC profile PFc of the screen 30 can be performed on the computer 10.

On the other hand, paying attention to the image display system 1, since the image display system 1 is structured so that the ICC profile PFc based on the characteristic of the screen 30 is read from the recording medium 9 and stored, the image data to be projected onto the screen 30 is color-corrected based on the ICC profile PFc and the image is projected onto the screen 30 based on the color-corrected image data, color correction based on the characteristic of the screen 30 can be performed.

Moreover, since the image display system 1 is structured so that by inputting the angle information DA corresponding to the angle between the line of sight when the image displayed on the screen 30 is viewed and the display screen of the screen 30, the image data to be displayed on the screen 30 is corrected according to the angle information DA and image projection is performed, the viewer can view an appropriate displayed image.

Further, since the image display system 1 is structured so that by inputting the ambient light information DB on the ambient light with which the screen 30 is irradiated, the image data to be projected onto the screen 30 is corrected according to the ambient light information DB and image projection is performed, the image for projection can be generated with consideration given to the effect of the ambient light on the projected image, so that appropriate image display can be performed even when the screen 30 is irradiated with ambient light.

While an embodiment of the present invention has been described, the present invention is not limited to the above-described contents.

For example, while a case where the profile conversion 40 and the gamut adjustment 42 are performed in the computer 10 is shown as an example in the description given above, these processings maybe performed in the projector 20. In this case, the ICC profile PFc of the screen 30, the angle information DA and the ambient light information DB are input to the projector 20.

Moreover, while a case where a profile conversion based on the ICC profile PFc of the screen 30, the angle information DA and the ambient light information DB is performed in the profile conversion 40 is shown as an example in the description given above, a profile conversion reflecting one of the ICC profile PFc of the screen 30, the angle information DA and the ambient light information DB may be performed.

Moreover, while a case where the display on which an image is displayed is the screen 30 is shown as an example in the description given above, when an image is displayed on a liquid crystal display, the image display condition may also be changed according to the angle at which the liquid crystal display is viewed.

As described above, by inputting the angle information corresponding to the angle between the line of sight and the display screen and correcting the image data to be displayed on the display according to the angle information to perform image display, the image display condition can be changed according to the direction of the viewer's line of sight, so that appropriate image display can be performed to the viewer. Consequently, when the viewer views the image displayed on the display, an image with high reproducibility which image is faithful to the original image and reflects the direction of the viewer's line of sight can be viewed.

In addition, since the image data to be projected onto the screen is color-corrected according to the angle information, an image with appropriate color reproducibility can be projected to the viewer.

By inputting the ambient light information on the ambient light with which the screen is irradiated and correcting the image data to be projected onto the screen according to the ambient light information to perform image projection, the image display condition can be changed according to the condition of the ambient light, so that appropriate image display can be performed. Consequently, the viewer can view an image with high reproducibility which image is faithful to the original image and takes the effect of the ambient light into consideration.

In addition, since the image data to be projected onto the screen is color-corrected according to the ambient light information, an image with appropriate color reproducibility can be projected.

By storing color correction information based on the characteristic of the screen and color-correcting the image data to be projected onto the screen based on the color correction information to perform image projection, the image to be projected can be color-corrected according to the characteristic of the screen, so that an image with appropriate color reproducibility can be projected onto the screen. Consequently, the viewer can view an image with high reproducibility which image is faithful to the original image and reflects the characteristic of the screen.

In addition, since second color correction information based on the characteristic of the projector is stored, the second color correction information is converted based on first color correction information and the image data to be projected onto the screen is color-corrected by using the converted color correction information, for example, even when color correction cannot be performed with only the first color correction information, color correction can be performed appropriately, so that an image with appropriate color reproducibility can be projected onto the screen. Moreover, by performing the processing to perform color correction once, color correction reflecting both the first color correction information and the second color correction information can be performed

In addition, since the angle information on the angle between the axis of projection and the line of sight is input, the second color correction information is converted based on the angle information and the image data to be projected onto the screen is color-corrected by using the converted color correction information, an image with appropriate color reproducibility can be projected to the viewer.

In addition, since the ambient light information on the ambient light with which the screen is irradiated is input, the second color correction information is converted based on the ambient light information and the image data to be projected onto the screen is color-corrected by using the converted color correction information, an image with color reproducibility appropriate for the condition of the ambient light can be projected.

By recording on a computer-readable recoding medium color correction information when an image is projected from the projector onto the screen which color correction information is based on the characteristic of the screen, color correction based on the characteristic of the screen can be performed on the computer, so that an image with appropriate color reproducibility can be projected onto the screen.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image display system for displaying an image on a surface of a display comprising:
an input part accepting input of angle information on an angle between a line of sight when an image displayed on the display is viewed, and the surface of the display;
a corrector correcting image data to be displayed on the display, according to the angle information; and
a display controller performing image display on the display based on the image data corrected by the corrector.

2. An image display system according to claim 1,
wherein the display is a screen, and
the display controller is provided in a projector for projecting image on the screen, so that the corrector corrects image data to be projected on the screen according to the angle information.

3. An image display system displaying an image by projecting the image onto a screen, comprising:
an input part accepting input of ambient light information on ambient light with which the screen is irradiated;
a corrector correcting image data to be projected onto the screen, according to the ambient light information; and
image projection part projecting image onto the screen based on the corrected image data.

4. An image display system according to claim 3, wherein said corrector corrects color of the image data.

5. An image display system displaying an image by projecting the image onto a screen, comprising:
a memory storing a first color correction information based on a characteristic of the screen;
a corrector correcting color of image data to be projected onto the screen, based on the color correction information; and
image projection part projecting image onto the screen based on the corrected image data.

6. An image display system according to claim 5,
wherein the memory stores a second color correction information based on a characteristic of the image projection part, and
the corrector converts the second color correction information based on the first color correction information, and corrects the image data based on the converted second color correction information.

7. An image display system according to claim 6,
wherein the image projection part includes input part accepting input of an angle information between an image projection axis and image viewing axis, and
the corrector further converts the second color correction information based on the angle information, and corrects the image data based on the converted color correction information.

8. An image display system according to claim 6,
wherein the image projection part includes input part accepting input of an ambient light information concerning ambient light by which the screen is irradiated, and
the corrector further converts the second color correction information based on the ambient light information, and corrects the image data based on the converted color correction information.
